(19) United States
(12) Patent Application Publication
(10) Pub. No.: US 2009/0273554 A1
(43) Pub. Date: Nov. 5, 2009

(54) ELECTRO-OPTICAL DEVICE

(75) Inventor: Shin Fujita, Suwa-shi (JP)

Correspondence Address: OLIFF & BERRIDGE, PLC, P.O. BOX 320850, ALEXANDRIA, VA, 22320-4850, US

(73) Assignee: EPSON IMAGING DEVICES CORPORATION, Azumino-shi (JP)

(21) Appl. No.: 12/428,909

(22) Filed: Apr. 23, 2009

(30) Foreign Application Priority Data
May 1, 2008 (JP) 2008-119953

(51) Int. Cl. G09G 3/36

(52) U.S. Cl. 345/94; 345/98

(57) ABSTRACT

Provided is an electro-optical device including: pixel electrodes provided in intersections of gate lines and data lines; counter electrodes provided to face the pixel electrodes with an electro-optical material interposed therebetween; and storage capacitors each of which one end is connected to each of the pixel electrodes, wherein, if data line signals supplied to the pixel electrodes via the data lines correspond to writing of a positive polarity with respect to the potential of the counter electrodes, the potential of the other end of each of the storage capacitors is changed to a high potential side after the data line signals are written and, if the data line signals correspond to writing of a negative polarity with respect to the potential of the counter electrodes, the potential of the other end of each of the storage capacitors is held at a constant level before and after the data line signals are written.

### BACKGROUND

1. Technical Field

The present invention relates to an electro-optical device and, more particularly, an electro-optical device including a pixel electrode and a counter electrode facing the pixel electrode, such as a liquid crystal display device.

2. Related Art

In the related art, a display device including a pixel electrode and a counter electrode facing the pixel electrode is known (for example, see JP-A-2002-196358).

In JP-A-2002-196358, a liquid crystal display device including the pixel and counter electrodes which face each other with liquid crystal interposed therebetween and a storage capacitance (storage capacitor) for holding the potential of the pixel electrode is disclosed. In the liquid crystal display device described in JP-A-2002-196358, if a written video signal has a high potential, the potential of the storage capacitance is changed to the high potential side after the video signal is written and, if the written video signal has a low potential, the potential of the storage capacitance is changed to the low potential side after the video signal is written.

However, in the liquid crystal display device described in JP-A-2002-196358, if the above-described operation is performed, the potential of the pixel electrode is changed to the high potential side and the low potential side by changing the potential of the storage capacitor, and the amplitude of the potential of the pixel electrode is increased by the change to the high potential side and the low potential side. Accordingly, since the amplitude of a gate signal for controlling ON/OFF of the writing of the video signal to the pixel electrode should be also increased, it is difficult to reduce power consumption.

### SUMMARY

An advantage of some aspects of the invention is that it provides an electro-optical device capable of reducing power consumption.

According to a first aspect of the invention, there is provided an electro-optical device including: pixel electrodes provided in intersections of gate lines and data lines; counter electrodes provided to face the pixel electrodes with an electro-optical material interposed therebetween; and storage capacitors each of which one end is connected to each of the pixel electrodes, wherein, if data line signals supplied to the pixel electrodes via the data lines correspond to writing of a positive polarity with respect to the potential of the counter electrodes, the potential of the other end of each of the storage capacitors is changed to a high potential side after the data line signals are written and, if the data line signals correspond to writing of a negative polarity with respect to the potential of the counter electrodes, the potential of the other end of each of the storage capacitors is held at a constant level before and after the data line signals are written.

In the electro-optical device according to the first aspect of the invention, as described above, if the data line signals written to the pixel electrodes correspond to writing of a negative polarity (low potential side) with respect to the potential of the counter electrodes, the writing of the data line signals are controlled to be performed in a state in which the potential of the storage capacitors is held at a constant level, unlike the case where the written data line signals correspond to writing of a positive polarity (high potential side) with respect to the potential of the counter electrodes. That is, since the potential of the pixel electrodes is not changed to the low potential side after the writing of the data line signals to the pixel electrodes, it is possible to decrease the amplitude of the change in potential of the pixel electrodes. Accordingly, it is possible to decrease the amplitude of the signals (gate signals) for controlling the ON/OFF of the writing of the data line signals to the pixel electrodes. Therefore, it is possible to decrease power consumption at the time of writing the data line signals to the pixel electrodes by decreasing the amplitude of the gate signals.

The electro-optical device according to the first aspect may further include pixel transistors connected to the pixel electrodes; gate lines which supply gate signals for controlling ON/OFF of the pixel transistors; a gate line scanning unit which scans the gate lines; and a driving power source which supplies a driving power source potential to the gate line scanning unit, and an OFF potential of the gate signals supplied to the pixel transistors may become a reference potential of the electro-optical device. By this configuration, since the ON potential and the OFF potential (reference potential) of the gate signals are controlled at only the high potential side (positive polarity side) with reference to the reference potential, it is possible to drive the gate lines without separately providing a power source at the side of the negative polarity with respect to the reference potential. Accordingly, it is possible to suppress the increase in the number of power sources.

In this case, electro-optical device may further include capacitive lines connected to the storage capacitors; and capacitive line control circuits which control the potentials of the storage capacitors via the capacitive lines, wherein the capacitive line control circuits are connected to the gate lines, and control the potentials of the storage capacitors on the basis of the gate signals supplied from the gate lines. By this configuration, since the potential of the storage capacitors can be controlled without separately generating the signal for controlling the potential of the storage capacitors, it is possible to suppress complication of the circuit.

In the electro-optical device including the capacitive lines and the capacitive line control circuits, the capacitive line control circuits may be provided in the capacitive lines, respectively, a plurality of pixels having the pixel transistors, and a dummy gate line connected to the capacitive line control circuit arranged in correspondence with the capacitive line of a first stage may be further included, and a signal for controlling the potential of the storage capacitors corresponding to the capacitive line of the first stage may be supplied from the capacitive line control circuit arranged in correspondence with the capacitive line of the first stage to the capacitive line of the first stage, on the basis of a dummy gate signal supplied by the dummy gate line. By this configuration, it is possible to easily control the potential of the storage capacitors corresponding to the capacitive line of the first stage on the basis of the dummy gate signal.

In the configuration including the plurality of pixels, the plurality of pixels may be arranged in a matrix, and the data line signals supplied to the pixel electrodes may be switched to the data line signals of the positive polarity with respect to the potential of the counter electrodes and the data line signals of the negative polarity with respect to the potential of the counter electrodes, for each horizontal line of the plurality of pixels arranged in the matrix. By this configuration, since the data line signal corresponding to the high potential side and the data line signal corresponding to the low potential side are alternately supplied to the plurality of pixels for each horizontal line, it is possible to suppress generation of an image sticking phenomenon of liquid crystal.

In the configuration including the plurality of pixels, the capacitive line and the capacitive line control circuit may be provided one by one in the pixels of one row. By this configuration, it is possible to control the potential of the storage capacitors with certainty for every pixels of one row.

In the configuration including the plurality of pixels, the capacitive line and the capacitive line control circuit may be provided one by one in the pixels of a plurality of rows. By this configuration, since one capacitive line corresponds to the pixels of the plurality of rows, it is possible to suppress the increase in the number of capacitive lines. Therefore, it is possible to increase the transmissivity of the light source in each of the pixels by decreasing the number of capacitive lines. That is, it is possible to increase the aperture ratio of the pixels. In addition, it is possible to simplify the circuit configuration by decreasing the number of capacitive line control circuits.

In this case, a first writing mode for sequentially performing writing from the pixels of a previous stage to the pixels of a next stage one stage by one stage for each vertical period and a second writing mode for sequentially performing writing in order opposite to the first writing mode from the pixels of the previous stage to the pixels of the next stage for every two stages may be alternately performed at the time of writing the data line signals.

In the configuration including the plurality of pixels, the electro-optical device may further include gate line scanning units which scan the gate lines; and a display unit including the plurality of pixels, and the gate line scanning units may be arranged at positions sandwiching the display unit one by one. By this configuration, since two gate line scanning units are provided with the display unit interposed therebetween, the distance of the gate line from the gate line scanning unit to the pixels can be decreased compared with the case where one gate line scanning unit is arranged. Accordingly, it is possible to suppress the increase in wire resistance and wire capacity. As a result, since a time constant can be reduced, it is possible to write the data line signals to the pixels with accuracy.

According to a second aspect of the invention, there is provided an electronic apparatus including the electro-optical device having the above-described configuration. By this configuration, it is possible to obtain an electronic apparatus with low power consumption.

### BRIEF DESCRIPTION OF THE DRAWINGS

The invention will be described with reference to the accompanying drawings, wherein like numbers reference like elements.

FIG. 1 is a block diagram showing the whole configuration of a liquid crystal display device according to a first embodiment of the invention.

FIG. 2 is a circuit diagram showing the configuration of the liquid crystal display device according to the first embodiment of the invention.

FIG. 3 is a timing chart explaining an operation when a video signal is written, in the liquid crystal display device according to the first embodiment of the invention.

FIG. 4 is a view explaining a potential change when the video signal is written, in the liquid crystal display device according to the first embodiment of the invention.

FIG. 5 is a view explaining a potential change when the video signal is written, in the liquid crystal display device according to the first embodiment of the invention.

FIG. 6 is a view explaining a potential change when the video signal is written, in the liquid crystal display device according to the first embodiment of the invention.

FIG. 7 is a view explaining a potential change when the video signal is written, in the liquid crystal display device according to the first embodiment of the invention.

FIG. 8 is a view showing an example of an electronic apparatus using the liquid crystal display device according to the first embodiment of the invention.

FIG. 9 is a view showing an example of an electronic apparatus using the liquid crystal display device according to an embodiment of the invention.

FIG. 10 is a block diagram showing the whole configuration of a liquid crystal display device according to a second embodiment of the invention.

FIG. 11 is a circuit diagram showing the configuration of the liquid crystal display device according to the second embodiment of the invention.

FIG. 12 is a timing chart explaining an operation when a video signal is written, in the liquid crystal display device according to the second embodiment of the invention.

FIG. 13 is a circuit diagram showing the configuration of a liquid crystal display device according to a third embodiment of the invention.

FIG. 14 is a timing chart explaining an operation when a video signal is written, in the liquid crystal display device according to the third embodiment of the invention.

### DESCRIPTION OF EXEMPLARY EMBODIMENTS

Hereinafter, the embodiments of the invention will be described with reference to the accompanying drawings.

### First Embodiment

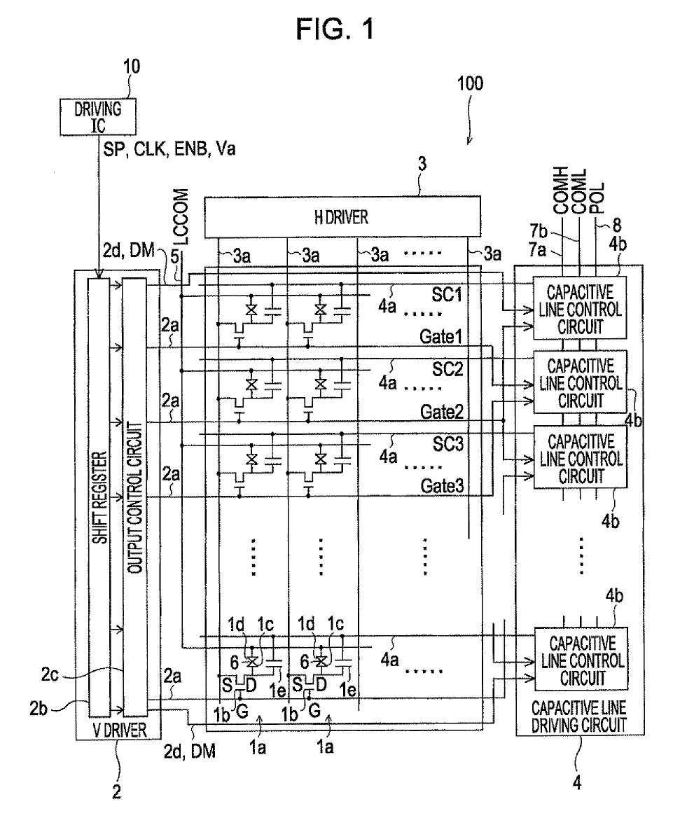

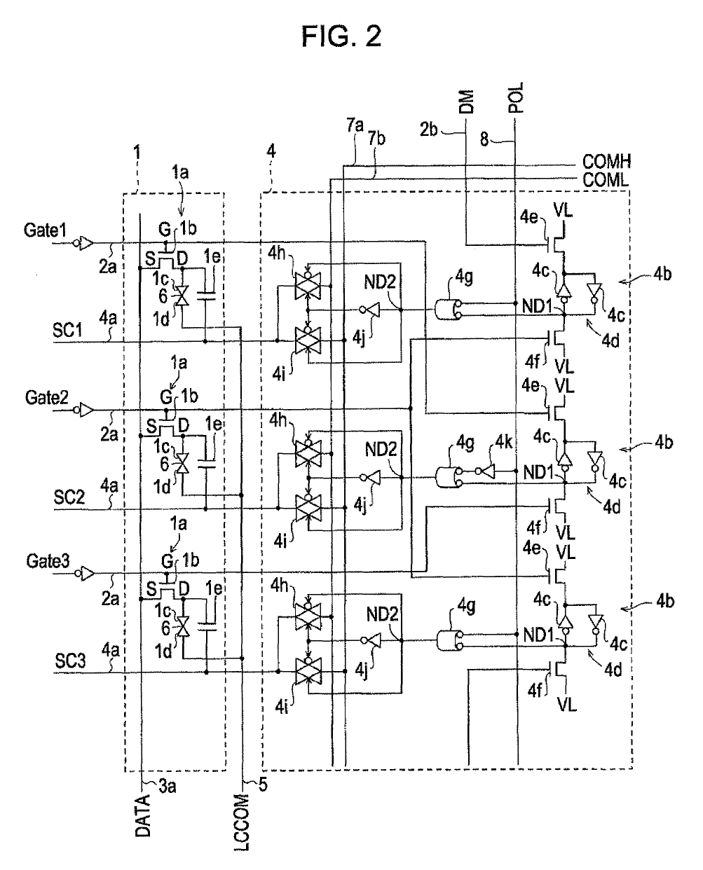

FIG. 1 is a block diagram showing the whole configuration of a liquid crystal display device according to a first embodiment of the invention. FIG. 2 is a circuit diagram showing the detailed configuration of the liquid crystal display device according to the first embodiment of the invention. First, the configuration of the liquid crystal display device 100 according to the first embodiment of the invention will be described with reference to FIGS. 1 and 2. In addition, in the first embodiment, an example of applying the invention to a liquid crystal display device which is an example of an electro-optical device will be described.

The liquid crystal display device 100 according to the first embodiment of the invention includes, as shown in FIG. 1, a display screen unit 1, a V driver 2, an H driver 3, and a capacitive line driving circuit unit 4. In the display screen unit 1, a plurality of pixels 1a are arranged in a matrix. In addition, in FIG. 1, eight pixels La are shown for simplification of the drawing. In addition, the V driver 2 is an example of a “gate line scanning unit” of the invention.

A plurality of gate lines 2a and data lines 3a are connected to the V driver 2 and the H driver 3, respectively. The gate lines 2a and the data lines 3a are arranged to perpendicularly intersect each other. In addition, the pixels 1a are arranged at the positions where the gate lines 2a and the data lines 3a perpendicularly intersect each other.

The V driver 2 includes a shift register 2b and an output control circuit 2c, and functions as a driving circuit of the gate lines 2a. In detail, a sampling pulse (SP), a clock signal (CLK), an enable signal (ENB) and a driving power source potential (Va) are supplied from a driving IC 10 to the shift register 2b of the V driver 2, and output signals are generated from the shift register 2b on the basis of these signals and the driving power source potential. In addition, these output signals are sequentially supplied to the output control circuit 2c, and gate signals output from the output control circuit 2c to the gate lines 2a. In addition, the H driver 3 has a function for sequentially supplying video signals supplied from the driving IC 10 to the below-described pixel electrodes 1c via the data lines 3a. In addition, the driving IC 10 is an example of a “driving power source” of the invention and the video signals are an example of “data line signals” of the invention.

Each of the pixels 1a includes a pixel transistor 1b (TFT), a pixel electrode 1c, a counter electrode 1d, and a storage capacitor 1e. A source area S of the pixel transistor 1b is connected to the data line 3a, and a drain area D of the pixel transistor 1b is connected to one electrode of the pixel electrode 1c and one electrode of the storage capacitor 1e (which is an example of “one end of the storage capacitor” of the invention). In addition, a gate G of the pixel transistor 1b is connected to the gate line 2a. In addition, the counter electrode 1d is connected to a CON driver (not shown) via an LCCOM line 5. In addition, the other electrode of the storage capacitor 1e (which is an example of “the other end of the storage capacitor” of the invention) is connected to a capacitive line 4a, and the capacitive line 4a is connected to the capacitive line driving circuit unit 4. Liquid crystal 6 is filled between the pixel electrode 1c and the counter electrode 1d.

In the first embodiment, the capacitive line driving circuit unit 4 includes a plurality of capacitive line control circuits 4b which are respectively provided in the capacitive lines 4a (SC1, SC2, SC3, . . . of the drawing).

Each of the capacitive line control circuits 4b has a function for driving the capacitive line 4a corresponding thereto. In the pixels 1a of one row, the capacitive line 4a and the capacitive line control circuit 4b are provided one by one.

The gate line 2a connected to the pixels 1a of the row of a previous stage and the gate line 2a connected to the pixels 1a of the row of a next stage are connected to each of the capacitive line control circuits 4b. In detail, for example, in FIG. 1, the gate line 2a (Gate1 of the drawing) connected to the pixels 1a of the row of the previous stage and the gate line 2a (Gate3 of the drawing) connected to the pixels 1a of the row of the next stage are connected to the capacitive line control circuit 4b corresponding to the pixels 1a of the row of a second stage.

In the first embodiment, the gate line 2a (Gate2 of the drawing) connected to the pixels 1a of the row of the next stage and a dummy gate line 2d (DM of the drawing) are connected to the capacitive line control circuit 4b corresponding to the pixels 1a of the row of a first stage.

In the first embodiment, a COMH line 7a for supplying a potential level (COMH of the drawing) of a COMH signal to the storage capacitor 1e via the capacitive line 4a and a COML line 7b for supplying a potential level (COML of the drawing) of a COML signal to the storage capacitor 1e via the capacitive lines 4a are connected to each of the capacitive line control circuits 4b. In addition, the COMH signal is a signal having an H level for changing the potential of the storage capacitor 1e to a high potential side, and the COML signal is a signal having an L level for changing the potential of the storage capacitor 1e to a low potential side (a low potential with respect to the high potential side). In addition, a POL line 8 which supplies a polarity selection signal (POL of the drawing) for selecting which of the COMH signal and the COML signal is output from each of the capacitive line control circuits 4b to the capacitive line 4a is connected to each of the capacitive line control circuits 4b.

As described above, each of the capacitive line control circuits 4b is configured to output any one of the COMH signal and the COML signal to the capacitive line 4a corresponding thereto on the basis of a dummy gate signal or the gate signal and the polarity selection signal. The detailed operation will be described later.

Next, the detailed circuit diagram of the capacitive line driving circuit unit 4 will be described. As shown in FIG. 2, the capacitive line control circuits 4b have different circuit configurations according to an odd-numbered stage and an even-numbered stage. First, the circuit configuration of the capacitive line control circuit 4b of the odd-numbered stage will be described. Each of the capacitive line control circuits 4b includes a latch circuit 4d including two inverters 4c, transistors 4e and 4f, a NAND circuit 4g, switches 4h and 4i including transfer gate transistors, and an inverter 4j. In addition, each of the switches 4h and 4i (transfer gate transistors) is configured by connecting an n-type MOS transistor and a p-type MOS transistor in parallel.

One of the source and the drain of the transistor 4e is connected to one connection portion of the latch circuit 4d, and a signal having the L level (VL of the drawing) is supplied to the other of the source and the drain of the transistor 4e. Similarly, one of the source and the drain of the transistor 4f is connected to the other connection portion of the latch circuit 4d via a node 1 (ND1). In addition, the signal having the L level (VL) is supplied to the other of the source and the drain of the transistor 4f.

The node 1 (ND1) which is the connection portion between the latch circuit 4d and the transistor 4f is connected to one input side of the NAND circuit 4g. In addition, the other input side of the NAND circuit 4g is connected to the POL line 8. The output side of the NAND circuit 4g is connected to the input side of the inverter 4j via a node 2 (ND2). In addition, the output side of the NAND circuit 4g is connected to the gate of the p-type transistor side of the switch 4h and the gate of the n-type transistor side of the switch 4i, at the node 2 (ND2). The output side of the inverter 4j is connected to the gate of the n-type transistor side of the switch 4h and the gate of the p-type transistor side of the switch 4i. One connection portion of the switch 4h is connected to the COML line 7b and the other connection portion thereof is connected to the capacitive line 4a. In addition, one connection of the switch 4i is connected to the COMH line 7a and the other connection portion thereof is connected to the capacitive line 4a.

The capacitive line control circuit 4b of the even-numbered stage has a configuration obtained by adding an inverter 4k to the configuration of the capacitive line control circuit 4b of the odd-numbered stage. In detail, for example, as shown in the capacitive line control circuit 4b of a second stage, the other input side of the NAND circuit 4g is connected to the output side of the inverter 4k and the input side of the inverter 4k is connected to the POL line 8.

In the capacitive line control circuits 4b of the odd-numbered stage and the even-numbered stage, the gate line 2a corresponding to the pixels 1a of the row of the previous stage is connected to the gate of the transistor 4e, and the gate line 2a corresponding to the pixels 1a of the row of the next stage is connected to the gate of the transistor 4f. In detail, for example, the gate line 2a corresponding to the pixels 1a of the row of the previous stage (the gate line 2a corresponding to Gate1) is connected to the gate of the transistor 4e in the capacitive line control circuit 4b of the second stage and the gate line 2a corresponding to the pixels 1a of the row of the next stage (the gate line 2a corresponding to Gate3) is connected to the gate of the transistor 4f. In addition, the dummy gate line 2d is connected to the gate of the transistor 4e in the capacitive line control circuit 4b of the first stage.

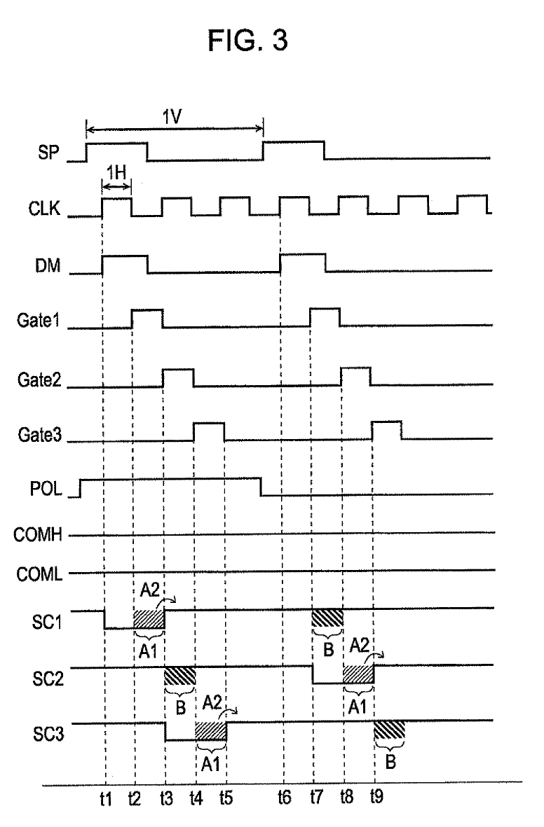

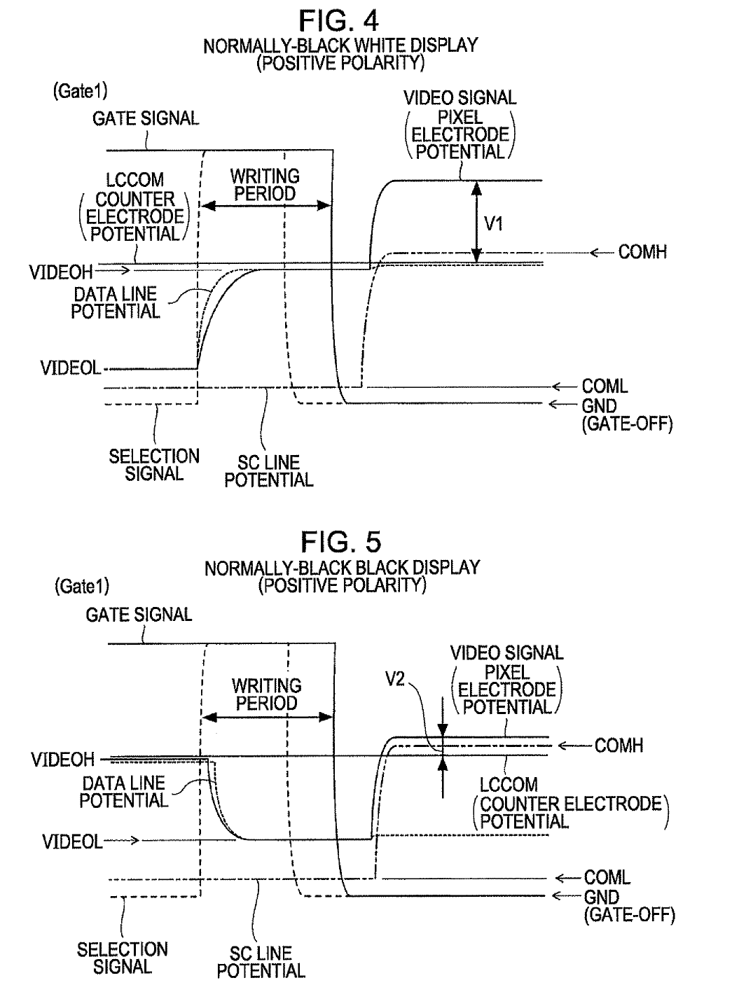

FIG. 3 is a timing chart explaining an operation when a video signal is written, in the liquid crystal display device according to the first embodiment of the invention. FIGS. 4 to 7 are views explaining the detailed operation when the video signal is written, in the liquid crystal display device according to the first embodiment of the invention. Next, the operation when the video signal is written in the liquid crystal display device 100 according to the first embodiment of the invention will be described with reference to FIGS. 2 to 7.

First, as shown in FIG. 3, in one first vertical period (1V period of the drawing), the polarity selection signal (POL of FIG. 3) having the H level is continuously supplied from the POL line 8 (see FIG. 2). At this time, at a time t1, the dummy gate signal having the H level is supplied to the gate of the transistor 4e in the capacitive line control circuit 4b of the first stage via the dummy gate line 2d on the basis of the clock signal. Accordingly, the signal having the L level (VL of FIG. 2) is supplied to the latch circuit 4d via the source and the drain of the transistor 4e. At this time, the signal having the L level is inverted by the inverter 4c in the latch circuit 4d and is stored (latched) such that the node 1 (ND1) side of the latch circuit 4d is held at the H level. Accordingly, the signal having the H level is supplied from the latch circuit 4d to one input side of the NAND circuit 4g via the node 1 (ND1).

At this time, since the signal having the H level is supplied to the other input side of the NAND circuit 4g via the POL line 8, the signal having the L level is output from the output side of the NAND circuit 4g. The signal having the L level is supplied to the gates of the transistors respectively configuring the switch 4h and 4i via the node 2 (ND2). In the switch 4i, the signal having the L level is held at an OFF state so as to be supplied to the gate of the n-type MOS transistor side. In contrast, in the switch 4h, the signal having the L level is held at an ON state so as to be supplied to the gate of the p-type MOS transistor side. Accordingly, the COML signal (L level) is supplied from the COML line 7b to the capacitive line 4a of the first stage (SC1 of FIG. 2) via the switch 4h switched to the ON state, That is, at the time t1 of FIG. 3, SC1 (the potential of the capacitive line 4a of the first stage) is changed to the L level.

In the first embodiment, in this state, at a time t2 of FIG. 3, the gate line 2a (Gate1 of the drawing) corresponding to the pixels 1a of the row of first stage becomes the ON state such that the video signal is written to the pixels 1a of the row of the first stage. At this time, the video signal corresponding to the high potential side (the writing of the positive polarity with respect to the potential of the counter electrode 1d) is supplied to the pixels 1a of the row of the first stage. That is, the video signal corresponding to the high potential side is written when SC1 (the potential of the capacitive line 4a of the first stage) is at the L level (a portion A1 of FIG. 3). In addition, the video signal is written to the pixels 1a of the first stage in a period from the time t2 to a time t3 (a period in which Gate1 is in an ON state).

At the time t2, the ON signal supplied from the gate line 2a of Gate1 is input to the gate of the transistor 4e in the capacitive line control circuit 4b corresponding to the capacitive line 4a of the second stage (SC2 of FIG. 2), as shown in FIG. 2. Accordingly, the signal having the L level is supplied to the latch circuit 4d via the source and the drain of the transistor 4e and is stored in the latch circuit 4d such that the node 1 (ND1) side becomes the H level. The signal having the H level is input from the latch circuit 4d to one input side of the NAND circuit 4g in the capacitive line control circuit 4b of the second stage via the node 1 (ND1).

The signal having the H level supplied from the POL line 8 is inverted to the L level state by the inverter 4k and is supplied to the other input side of the NAND circuit 4g. Accordingly, the signal of the H level is output from the output side of the NAND circuit 4g and the signal having the H level is input to the gate of the n-type transistor side of the switch 4i such that the switch 4i in the capacitive line control circuit 4b of the second stage becomes the ON state. In addition, the switch 4h is held at the OFF state. The COMH signal (H level) from the COMH line 7a is supplied to the capacitive line 4a of the second stage (SC2 of FIG. 2) via the switch 4i. That is, at the time t2 of FIG. 3, SC2 (the potential of the capacitive line 4a of the second stage) is held at the H level state.

At the time t3 of FIG. 3, the writing of the video signal to the pixels 1a of the first stage is finished and the gate signal having the H level is supplied from the gate line 2a (Gate2) corresponding to the pixels 1a of the second stage.

At this timer in the first embodiment, the gate signal output from the gate line 2a corresponding to Gate2 is supplied to the gate of the transistor 4f in the capacitive line control circuit 4b of the first stage. Accordingly, the signal having the L level (VL of the drawing) is supplied to the latch circuit 4d via the source and the drain of the transistor 4f. The signal having the L level is stored in the latch circuit 4d such that the node 1 (ND1) side becomes the L level state, and is supplied to one input side of the NAND circuit 4g via the node 1 (ND1) Accordingly, the signal having the H level is continuously supplied from the POL line 8 to the other input side of the NAND circuit 4g such that the signal having the H level is output from the output side of the NAND circuit 4g.

By the signal having the H level, the switch 4i is turned on and the switch 4h is turned off. Accordingly, the COMH signal (H level) is supplied to the capacitive line 4a of the first stage via the switch 4i. That is, at the time t3 of FIG. 3, the potential of the storage capacitor 1e corresponding to the capacitive line 4a of the first stage (SC1 of FIG. 3) is changed from the low potential side to the high potential side. Accordingly, the potential of the pixel electrodes 1c of the pixels 1a of the row of the first stage, to which the video signal corresponding to the high potential side (the writing of the positive polarity with respect to the potential of the counter electrode 1d) is written, is changed to the high potential side by the change in potential of the storage capacitor 1e to the high potential (the voltage corresponding to the potential of the COMH signal—the potential of the COML signal) (a portion A2 of FIG. 3).

In the first embodiment, at the time t3, the writing of the video signal to the pixels 1a of the row of the second stage is performed. The video signal corresponding to the low potential side (the writing of the negative polarity with respect to the potential of the counter electrode 1d) is supplied to the pixels 1a of the row of the second stage. That is, the liquid crystal display device 100 of the first embodiment is driven by one horizontal period inversion driving, in which the video signal supplied to the pixel electrodes 1c can be switched between the high potential side and the low potential side, for every row of the pixels 1a. At this time, the potential of the capacitive line 4a of the second stage (SC2) is held at the high potential side. That is, with respect to the pixels 1a of the row of the second stage, the video signal corresponding to the low potential side (the writing of the negative polarity with respect to the potential of the counter electrode 1d) is written to the pixel electrodes 1c, in a state in which the potential of the storage capacitor 1e is held at the high potential side (a portion B of FIG. 3).

At this time, at the time t3, the ON signal output from the gate line 2a corresponding to Gate2 is supplied to the gate of the transistor 4e in the capacitive line control circuit 4b of the third stage. Accordingly, in the capacitive line control circuit 4b of the third stage, the same operation as the operation of the capacitive line control circuit 4b of the first stage is performed. That is, the switch 4h becomes the ON state and the COML signal (L level) is supplied to the capacitive line 4a of the third stage (SC3 of FIG. 2) via the switch 4h. Accordingly, the potential of SC3 (the potential of the capacitive line 4a of the third stage) of FIG. 3 becomes the L level at the time t3.

In this state, at a time t4, the ON signal is supplied to the gate line 2a corresponding to the pixels 1a of the third stage (Gate3 of FIG. 2) and the writing of the video signal is performed with respect to the pixels 1a of the third stage. The video signal corresponding to the high potential side is written in the pixels 1a of the third stage by one horizontal period inversion driving, similar to the pixels 1a of the first stage.

At a time t5, the ON signal supplied to the gate line 2a corresponding to the pixels 1a of the third stage becomes the OFF state and the ON signal is supplied from the gate line 2a corresponding to the pixels 1a of the fourth stage (Gate4 (not shown)). This ON signal is supplied to the gate of the transistor 4f in the capacitive line control circuit 4b of the third stage such that the same operation as the capacitive line control circuit 4b of the first stage at the time t3 is performed. That is, the potential of the capacitive line 4a of the third stage held at the low potential side is changed to the high potential side such that the potential of the pixel electrodes 1c of the pixels 1a of the third stage, to which the video signal corresponding to the high potential side is written, is changed to the high potential side by the voltage corresponding to the transition (the potential of the COMH signal—the potential of the COML signal) of the capacitive line 4a.

Accordingly, in the first embodiment, the pixels 1a of the odd-numbered stage are controlled such that the video signal corresponding to the high potential side (the writing of the positive polarity with respect to the potential of the counter electrode) is written in a state in which the potential of the storage capacitor 1e is held at the low potential side, and the potential of the storage capacitor 1e is changed from the low potential side to the high potential side after the writing of the video signal. In addition, the pixels 1a of the even-numbered stage are controlled such that the video signal corresponding to the low potential side (the writing of the negative polarity with respect to the potential of the counter electrode) is written in a state in which the potential of the storage capacitor 1e is held at the high potential side.

The potential change at the time of writing the video signal (the video signal corresponding to the high potential side) to the pixels 1a of the odd-numbered stage will be described in detail.

First, a case of writing a video signal corresponding to a white display in a normally-black mode will be described with reference to FIG. 4. For example, when the gate line 2a corresponding to Gate1 (the gate line 2a corresponding to the pixels 1a of the first stage) is in the ON state, the writing of the video signal to the pixels 1a, to which a selection signal having the H level is supplied, is performed. The selection signal is a signal for selecting the pixels 1a to which the video signal is written.

In detail, the video signal corresponding to the white display is supplied to the data line 3a such that the video signal is supplied to the pixel electrodes 1c via the data line 3a. Accordingly, in a writing period of FIG. 4, the potentials of the data line 3a and the pixel electrodes 1c become a level of VIDEOH. At this time, the potential of the capacitive line 4a of the first stage (the potential of the line SC of the drawing) is held at the level (L level) of COML. In addition, the gate signal becomes the OFF state, and the potential of the capacitive line 4a is changed from the COML state to the COMH state. Accordingly, the potential of the pixel electrodes 1c is changed to the high potential side.

At this time, the gate signal is in the OFF state and thus the pixel transistors 1b are in the OFF state. Accordingly, the potential of the data line 3a is hardly changed. Therefore, a difference between the potential of the counter electrode 1d held at a constant level (LCCOM of the drawing) and the potential of the pixel electrodes 1c changed to the high potential side (V1 of the drawing (a potential difference corresponding to the white display)) is applied to the liquid crystal 6.

As shown in FIG. 5, when a video signal corresponding to a black display in a normally-black mode is written, similar to the above description, the video signal is written in a writing period of the drawing. Accordingly, in the writing period, the potentials of the data line 3a and the pixel electrodes 1c become a level of VIDEOL, and the potential of the capacitive line 4a of the first stage (the potential of the line SC of the drawing) is held at the level (L level) of COML. In addition, the gate signal becomes the OFF state, and the potential of the capacitive line 4a is changed from the COML state to the COMH state. Accordingly, the potential of the pixel electrodes 1c is changed to the high potential side. Therefore, a difference between the potential of the counter electrode 1d (LCCOM of the drawing) and the potential of the pixel electrodes 1c changed to the high potential side (V2 of the drawing (a potential difference corresponding to the black display)) is applied to the liquid crystal 6.

Next, the potential change at the time of writing the video signal (the low potential side) to the pixels 1a of the even-numbered stage will be described in detail.

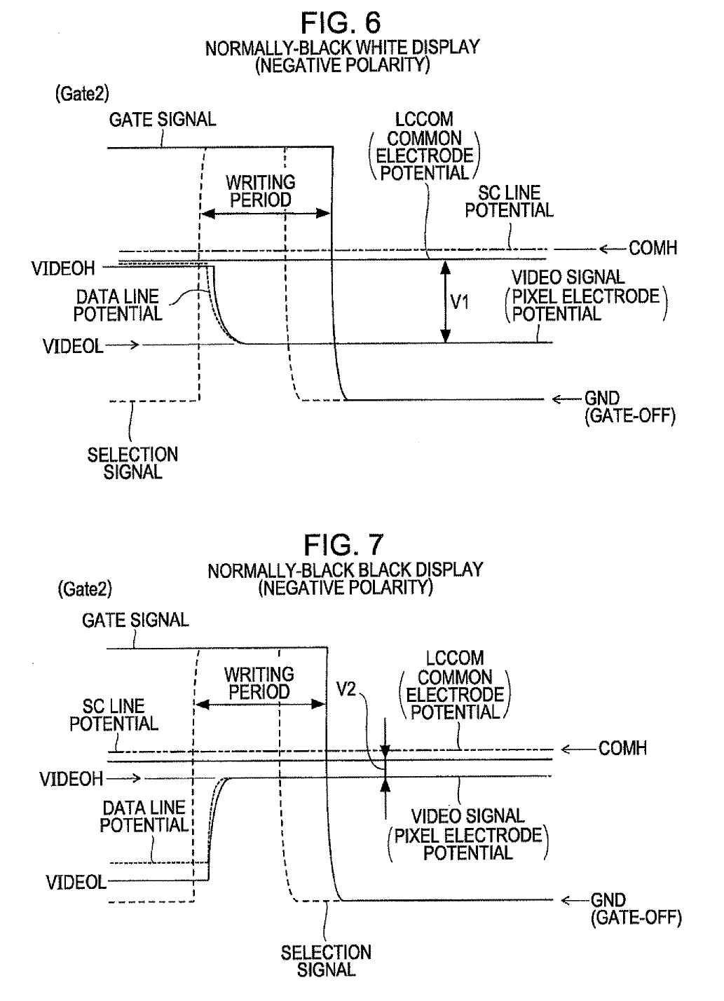

First, a case of writing a video signal corresponding to a white display in a normally-black mode will be described with reference to FIG. 6. For example, when the gate line 2a corresponding to Gate2 (the gate line 2a corresponding to the pixels 1a of the first stage) is in the ON state, the writing of the video signal is performed similar to the above description. In detail, in a writing period of FIG. 6, the potentials of the data line 3a and the pixel electrodes 1c become a level of VIDEOL. At this time, the potential of the capacitive line 4a of the second stage (the potential of the line SC of the drawing) is held at the level (H level) of COMH even after the gate signal becomes the OFF state. Accordingly, even after the writing of the video signal is finished, the potential of the capacitive line 4a is continuously held at the COMH state and thus the potential of the pixel electrodes 1c is not changed. In addition, since the pixel transistors 1b are in the OFF state, the potential of the data line 3a is hardly changed. Therefore, a difference between the potential of the counter electrode 1d held at a constant level (LCCOM of the drawing) and the potential of the pixel electrodes 1c (V1 of the drawing (a potential difference corresponding to the white display)) is applied to the liquid crystal 6.

As shown in FIG. 7, when a video signal corresponding to a black display in a normally-black mode is written, similar to the above description, in the writing period, the potentials of the data line 3a and the pixel electrodes 1c become a level of VIDEOH, and the potential of the capacitive line 4a of the second stage (the potential of the line SC of the drawing) is held at the level (H level) of COMH. In addition, the gate signal becomes the OFF state, and the writing of the video signal (black display) is finished. Even after the writing of the video signal is finished, the potential of the capacitive line 4a is continuously held at the COMH state and thus the potential of the pixel electrodes 1c is not changed. Therefore, a difference between the potential of the counter electrode 1d (LCCOM of the drawing) and the potential of the pixel electrodes 1c (V2 of the drawing (a potential difference corresponding to the black display)) is applied to the liquid crystal 6.

In the first embodiment, as shown in FIGS. 4 to 7, the OFF potential of the gate signal is a reference potential of the liquid crystal display device, that is, the same potential as a ground level (GND). Accordingly, in the liquid crystal display device 100 of the first embodiment, the operation for writing the video signal is performed by the potential of the positive polarity side with respect to the reference potential. In addition, the ground level (GND) is the reference potential when an electrical signal is exchanged, and may be called a ground potential or a low potential of a driving power source of the V driver 2.

As shown in FIG. 3, in one next vertical period (in and after a time t6), the polarity selection signal having the L level (POL of FIG. 3) is continuously supplied. In addition, the video signal corresponding to the low potential side is written to the pixels 1a of the odd-numbered stage, and the video signal corresponding to the high potential side is written to the pixels 1a of the even-numbered stage. In detail, the signal having the L level is supplied from the POL line 8 and, at the time t6, the dummy gate signal having the H level is supplied from the dummy gate line 2d to the gate of the transistor 4e in the capacitive line control circuit 4T of the first stage. Accordingly, the signal having the L level (VL) is supplied to the latch circuit 4d and the node 1 (ND1) side is inverted to the H level by the inverter 4c of the latch circuit 4d. The signal having the H level is supplied to one input side of the NAND circuit 4g and the signal (POL) having the L level is supplied to the other input side thereof such that the signal having the H level is output from the output side of the NAND circuit 4g. Accordingly, only the switch 4i becomes the ON state and the COMH signal (H level) is supplied to the capacitive line 4a (SC1) via the switch 4i. That is, at the time t6 shown in FIG. 3, the potential of the capacitive line 4a of the first stage (SC1) is continuously held at the H level.

At a time t7, the gate signal from Gate1 is supplied to the gate of the transistor 4e in the capacitive line control circuit 4b of the second stage such that the potential of the capacitive line 4a of the second stage (SC2) becomes the L level state. The gate line 2a corresponding to the pixels 1a of the first stage becomes the ON state by the gate signal from Gate1 such that the writing of the video signal is started. At this time, the video signal corresponding to the low potential side is supplied to the pixels 1a of the first stage. When the writing of the video signal to the pixels 1a of the first stage is performed, the potential of the capacitive line 4a is continuously held at the H level state.

At a time t8, the gate line 2a (Gate2) corresponding to the pixels 1a of the second stage becomes the ON state such that the video signal corresponding to the high potential side is written in a state in which the potential of the capacitive line 4a is held at the L level. At a time t9, the gate signal of the ON state is output from the gate line 2a (Gate3) corresponding to the pixels 1a of the third stage and the gate signal is supplied to the gate of the transistor 4f in the capacitive line control circuit 4b of the second stage. Accordingly, the potential of the capacitive line 4a of the second stage (SC2) and the potential of the pixel electrodes 1c of the pixels 1a of the second stage is changed to the high potential side (a portion A2 of the drawing). At this time, the video signal is written to the pixels 1a of the third stage (a portion B of the drawing).

As described above, in the first embodiment, the video signal corresponding to the high potential side and the video signal corresponding to the low potential side are alternately supplied to the pixels 1a of the odd-numbered stage and the pixels 1a of the even-numbered stage for each vertical period.

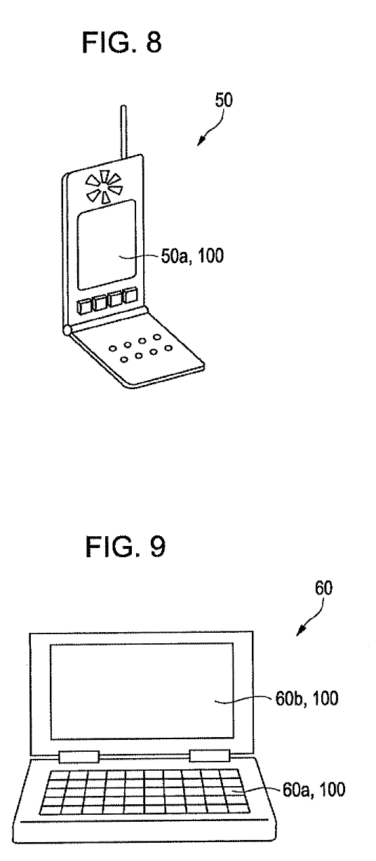

The liquid crystal display device 100 according to the first embodiment of the invention can be used in a mobile telephone 50, a personal computer (PC) 60 and so on, as shown in FIGS. 8 and 9. In the mobile telephone 50 of FIG. 8, the liquid crystal display device 100 of the first embodiment of the invention is used in a display screen 50a. In the PC 60 of FIG. 9, the liquid crystal display device can be used in an input unit such as a keyboard 60a or the like and a display screen 60b or the like. When a peripheral circuit is built in a substrate of a liquid crystal panel, it is possible to significantly decrease the number of components and realize reduction of the weight and the size of the device main body.

In the first embodiment, as described above, if the video signal written to the pixel electrodes 1c corresponds to the low potential side (the writing of the negative polarity with respect to the potential of the counter electrode 1d), the video signal is controlled to be written in a state in which the potential of the storage capacitor 1e is held at a constant level (LCCOM), unlike the case where the written video signal corresponds to the high potential side (the writing of the positive polarity with respect to the potential of the counter electrode 1d). That is, since the writing of the video signal is performed without changing the potential of the pixel electrodes 1c to the low potential side, the amplitude of the potential change of the pixel electrodes 1c can be reduced. Accordingly, since the amplitude of the gate signal for controlling the ON/OFF of the writing of the video signal can be decreased, it is possible to reduce power consumption at the time of writing the video signal.

In the first embodiment, since the OFF potential of the gate signal supplied to the pixel transistors 1b becomes the reference potential of the liquid crystal display device, that is, the same potential as the ground level (GND), such that the ON potential and the OFF potential of the gate signal only in the high potential side (the positive polarity side) with respect to the reference potential are controlled, it is possible to drive the gate line 2a without separately providing the power source of the low potential side (the negative polarity side) with respect to the reference potential. Accordingly, it is possible to suppress the increase in the number of power sources. In addition, the ground level (GND) is the reference potential when the electrical signal is exchanged and may be called the ground potential or the low potential of the driving power source of the V driver 2. Even in this case, since the gate line 2a can be driven without separately providing the power source of the low potential side (the negative polarity side) with respect to the low potential of the driving power source or the ground potential, it is possible to suppress the increase in the number of power sources.

In the first embodiment, since the potential of the storage capacitor 1e is controlled by the gate signal without separately generating the signal for controlling the potential of the storage capacitor 1e by connecting the capacitive line control circuit 4b to the gate line 2a and controlling the potential of the storage capacitor 1e on the basis of the gate signal supplied from the gate line 2a, it is possible to suppress the complication of the circuit.

In the first embodiment, in the capacitive line 4a of the first stage, by supplying the dummy gate signal to the capacitive line control circuit 4b of the first stage and controlling the potential of the storage capacitor 1e corresponding to the capacitive line 4a of the first stage on the basis of the dummy gate signal from the capacitive line control circuit 4b of the first stager it is possible to easily control the potential of the storage capacitor 1e corresponding to the capacitive line 4a of the first stage on the basis of the dummy gate signal.

In the first embodiment, since the video signal corresponding to the high potential side and the video signal corresponding to the low potential side are alternately supplied in a 1 H period by switching the video signal supplied to the pixel electrodes 1c to the video signal corresponding to the high potential side (the writing of the positive polarity with respect to the potential of the counter electrode) and the video signal corresponding to the low potential side (the writing of the negative polarity with respect to the potential of the counter electrode) for each horizontal period (1 H period) so as to perform the writing, it is possible to suppress the generation of an image sticking phenomenon of the liquid crystal 6.

In the first embodiment, by providing the capacitive line 4a and the capacitive line control circuit 4b one by one in the pixels 1a of one row, it is possible to control the potential of the storage capacitor 1e with certainty.

### Second Embodiment

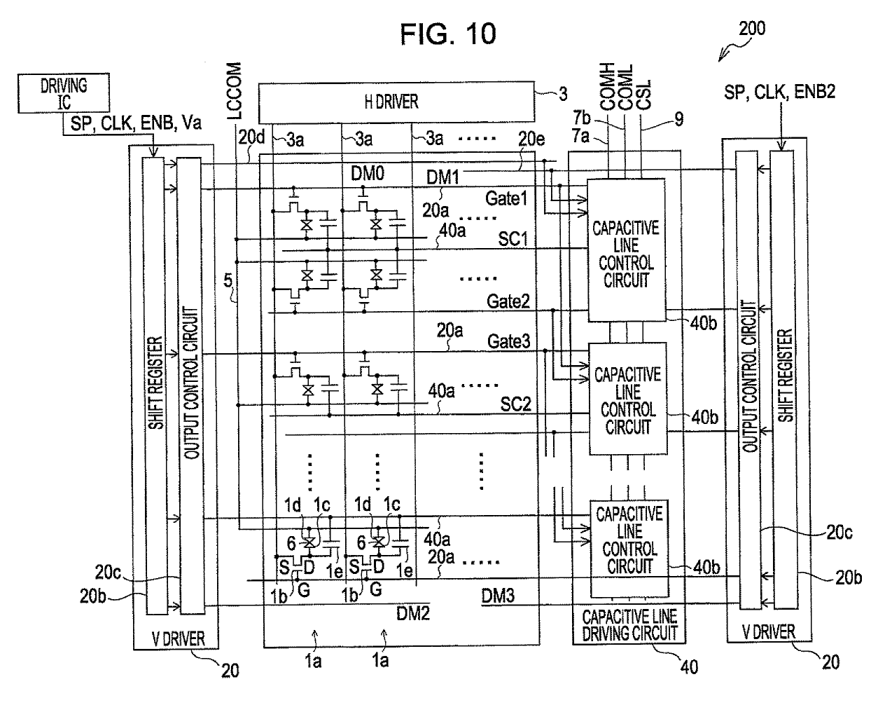

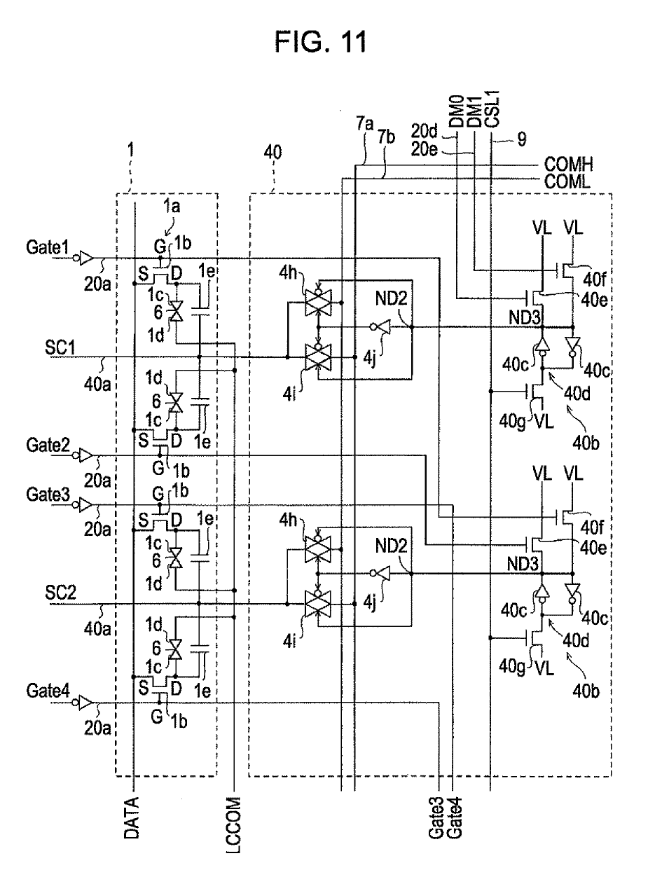

FIGS. 10 and 11 are views explaining the configuration of a liquid crystal display device according to a second embodiment of the invention. In the second embodiment, an example of providing a capacitive line 40a and a capacitive line control circuit 40b in the pixels 1a of two rows will be described with reference to FIGS. 10 and 11, unlike the first embodiment in which the capacitive line 4a and the capacitive line control circuit 4b are provided one by one in the pixels 1a of one row.

In the liquid crystal display device 200 of the second embodiment of the invention, as shown in FIG. 10, V drivers 20 including gate lines 20a are arranged one by one with the display screen unit 1 interposed therebetween. Each of the V drivers 20 includes a shift register 20b and an output control circuit 20c, and a sampling pulse (SP), a clock signal (CLK), an enable signal (ENB) and a driving power source potential (Va) are supplied from the driving IC 10. The gate lines 20a provided in one V driver 20 are respectively connected to the pixels 1a of the odd-numbered stage and the gate lines 20a provided in the other V driver 20 are respectively connected to the pixels 1a of the even-numbered stage. That is, the number of gate lines 20a driven by one V driver 20 of the second embodiment is a half of the number of gate lines 2a driven by the V driver 2 of the first embodiment.

In the second embodiment, the capacitive line driving circuit unit 40 is included, and, in the capacitive line driving circuit unit 40, the capacitive line 40a and the capacitive line control circuit 40b are provided one by one in the pixels 1a of two rows. Two gate lines 20a connected to the pixels 1a of two rows corresponding thereto are connected to each capacitive line control circuit 40b. In addition, a CSL line 9 for supplying a CSL signal is connected to each capacitive line control circuit 40b. The CSL signal has a function for driving each capacitive line control circuit 40b. In the second embodiment, the capacitive line control circuit 40b and the capacitive line 40a are driven on the basis of the CSL signal and the gate signal.

A dummy gate line 20d (DM0 of FIG. 10) and a dummy gate line 20e (DM1 of FIG. 10) are connected to the capacitive line control circuit 40b corresponding to the capacitive line 40a of a first stage (SC1 of FIG. 10). In addition, the dummy gate line 20d is connected to one V driver 20 and the dummy gate line 20e is connected to the other V driver 20.

Next, the detailed circuit diagram of the capacitive line driving circuit unit 40 of the second embodiment will be described. As shown in FIG. 11, all the capacitive line control circuit 40b have the same circuit configuration unlike the first embodiment in which the circuit configurations of the odd-numbered stage and the even-numbered stage are different from each other. In detail, each of the capacitive line control circuits 40b includes a latch circuit 40d including two inverters 40c and transistors 40e, 40f and 40g, and includes switches 4h and 4i including transfer gate transistors similar to the first embodiment.

One of the source and the drain of each of the transistors 40e and 40f is connected to one side of the latch circuit 40d via a node 3 (ND3). A signal having an L level (VL of the drawing) is supplied to the other of the source and the drain of each of the transistors 40e and 40f. In addition, the signal having the L level (VL of the drawing) is supplied to the other side of the latch circuit 40d. The dummy gate line 20d is connected to the gate of the transistor 40e, and the dummy gate line 20e is connected to the gate of the transistor 40f. In addition, the CSL line 9 is connected to the gate of the transistor 40g.

A node 2 (ND2) and a node 3 (ND3) are connected to each other. Accordingly, the latch circuit 40d is connected to the switch 4h, the switch 4i and an inverter 4j via the node 2 (ND2) and the node 3 (ND3).

The other configuration is equal to that of the first embodiment.

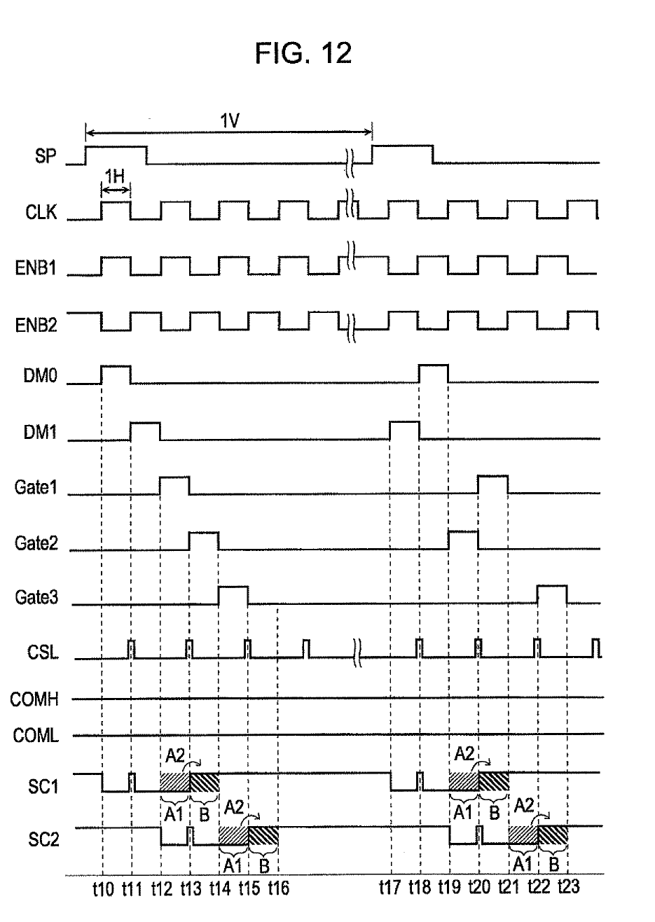

Next, the operation when the video signal is written in the liquid crystal display device 200 according to the second embodiment of the invention will be described with reference to FIGS. 11 and 12.

First, as shown in FIG. 12, in one first vertical period (1V period), an ON signal is output from the CSL line 9 for every two horizontal periods (2 H periods). At this time, at a time t10, a dummy gate signal (DM0) having an H level is supplied to the gate of the transistor 40e in the capacitive line control circuit 40b of the first stage via the dummy gate line 20d (see FIG. 11) on the basis of the clock signal. Accordingly, the signal having the L level (VL of FIG. 11) is stored in the latch circuit 40d via the source and the drain of the transistor 40e. At this time, the signal having the L level is supplied to the switches 4h and 4i via the node 3 (ND3) and the node 2 (ND2), and only the switch 4h is switched to the ON state. A COML signal is supplied to the capacitive line 40a (SC1) of the first stage via the switch 4h. That is, at a time t10, the potential of the capacitive line 40a of the first stage (the potential of SC1) becomes the L level state.

Next, at a time t11, the ON signal is supplied from the CSL line 9 to the gate of the transistor 40g.

Accordingly, the signal having the L level is supplied to the latch circuit 40d via the source and the drain of the transistor 40g and the node 3 (ND3) of the latch circuit 40d becomes the H level state. Accordingly, at the time t11, the signal having the H level is supplied to the switch 4i only in the period in which the CSL signal is in the ON state, and thus the switch 4i becomes the ON state. A COMH signal (H level) is supplied to the capacitive line 40a of the first stage via the switch 4i. Accordingly, at the time t1 of FIG. 12, the potential of the capacitive line 40a of the first stage (SC1) becomes the H level in the same period as the period in which the CSL signal is in the ON state.

At this time, a dummy gate signal having the H level (DM1) is supplied to the gate of the transistor 40f in the capacitive line control circuit 40b of the first stage via the dummy gate line 20e (see FIG. 11). Accordingly, the signal having the L level is supplied to the latch circuit 40d via the source and the drain of the transistor 40f and is stored in the latch circuit 40d such that the node 3 (ND3) side becomes the L level state. Similar to the above description, the switch 4h becomes the ON state such that the potential of SC1 becomes the L level.

Next, at a time t12, the ON signal is supplied to the gate 20a corresponding to the pixels 1a of the row of the first stage (Gate1 of FIG. 11) such that, with respect to the pixels 1a of the row of the first stage, the writing of a video signal corresponding to a high potential side is performed in a state in which the capacitive line 40a is held at a low potential side (a portion A1 of the drawing). At this time, the gate signal output from the gate line 20a (Gate1) is supplied to the gate of the transistor 40f in the capacitive line control circuit 40b of the second stage. Accordingly, in the capacitive line control circuit 40b of the second stage, the signal having the L level is supplied to the switches 4h and 4i via the node 3 (ND3) and the node 2 (ND2). Similar to the above description, only the switch 4h becomes the ON state such that the COML signal (L level) is supplied to the capacitive line 40a of the second stage. That is, at the time t12, the potential of the capacitive line 40a of the second stage (the potential of SC2) is changed to the L level.

At a time t13, the ON signal is output from the CSL line 9. At this time, in the capacitive line control circuit 40b of the first stage, the transistor 40g becomes the ON state and the signal having the L level is supplied to the latch circuit 40d such that the node 3 (ND3) becomes the H level state. The switch 4i becomes the ON state by the signal having the H level and the COMH signal (H level) is supplied to the capacitive line 40a of the first stage via the switch 4i. That is, at the time t13, the potential of the capacitive line 40a of the first stage (the potential of SC1) is changed to the high potential side, on the basis of the CSL signal. Accordingly, the potential of the pixel electrodes 1c of the pixels 1a of the row of the first stage to which the video signal is written is changed to the high potential side (a portion A2 of the drawing).

At this time, the CSL signal is supplied to the gate of the transistor 40g in the capacitive line control circuit 40b of the second stage. Accordingly, by the same operation as the above operation, the potential of the capacitive line 40a of the second stage (the potential of SC2) becomes the H level only in the same period as the period in which the CSL signal is in the ON state. At the time t13, the ON signal is output from the gate line 20a corresponding to the pixels 1a of the row of the second stage (Gate2 of the drawing). Accordingly, with respect to the row of the second stage, the writing of the video signal corresponding to the low potential side is performed to the pixels 1a in a state in which the potential of the capacitive line 40a is held at the high potential side (a portion B of the drawing).

At a time t14, the ON signal is output from the gate line 20a corresponding to the pixels 1a of the third stage (Gate3 of the drawing) such that, with respect to of the row of the third stage, the writing of the video signal corresponding to the high potential side to the pixels 1a is performed in a state in which the potential of the capacitive line 40a is held at the low potential side, similar to the above description. Accordingly, by the above configuration, the video signal corresponding to the high potential side and the video signal corresponding to the low potential side are sequentially alternately written to each row.

In one next vertical period (1V period), at a time t17, the dummy gate signal having the H level (DM1 of the drawing) is supplied from the dummy gate line 20e to the transistor 40f in the capacitive line control circuit 40b of the first stage. Accordingly, the switch 4i becomes the ON state and the COMH signal is supplied to the capacitive line 40a of the first stage (SC1). The potential of the capacitive line 40a of the first stage (the potential of SC1) is changed to the low potential side. At a time t18, the CSL signal having the H level is supplied to the gate of the transistor 40g in each of the capacitive line control circuits 40b, and the dummy gate signal having the H level (DM0 of the drawing) is supplied from the dummy gate line 20d to the gate of the transistor 40e in the capacitive line control signal 40b of the first stage. Accordingly, the capacitive line 40a of each of the stages is changed to the high potential side by supplying the COMH signal, on the basis of the CSL signal, and is immediately returned to the low potential side on the basis of the dummy age signal (DM0) in the capacitive line 40a of the first stage.

In this state, at a time t19, the gate signal having the H level is output from the gate line 20a corresponding to the pixels 1a of the second stage (Gate2) such that, with respect to the pixels 1a of the row of the second stage, the video signal corresponding to the high potential side is written in a state in which the potential of the capacitive line 40a is held at the low potential side. At a time t20, the CSL signal having the H level is supplied to each of the capacitive line control circuits 40b such that the potential of the capacitive line 40a of the first stage is changed to the high potential side. Accordingly, the potential of the pixel electrodes 1c of the pixels 1a of the row of the second stage, to which the video signal is written, is further changed to the high potential side. At this time, the gate lien 20a corresponding to the pixels 1a of the row of the first stage (Gate1) becomes the ON state such that, with respect to the pixels 1a of the row of the first stage, the video signal corresponding to the low potential side is written in a state in which the potential of the capacitive line 40a (the potential of SC1) is held at the high potential side. That is, the video signal is written to the pixels 1a of the second stage and the video signal is then drawn in the pixels 1a of the first stage. Even in the pixels 1a of the third stage or the subsequent stages thereof, first, the video signal of the pixels 1a of the fourth stage is written and the video signal is then written to the pixels 1a of the third stage.

In the second embodiment, a first writing mode for performing the writing in order of Gate1, Gate 2, Gate3, Gate4, . . . from the pixels 1a of the row of an upper stage, which becomes a previous stage, to the pixels 1a of the row of a lower stage, which becomes a next stage, for each vertical period and a second writing mode for performing the writing of the video image in order of Gate2, Gate1, Gate4, Gate3, . . . from the pixels 1a of the row of the lower stage, which becomes the next stage, to the pixels 1a of the row of the upper stage, which becomes the previous stage, for every rows of two stages are alternately performed. In addition, in the so-called reverse scanning in which the writing to the pixels is performed from the row of the lower stage to the row of the upper stage, reading is performed in a state in which the lower stage corresponds to the previous stage and the upper stage corresponds to the next stage.

The other operation of the second embodiment is equal to that of the first embodiment.

In the second embodiment, as described above, since one capacitive line 40a corresponds to the pixels 1a of two rows by providing the capacitive line 40a and the capacitive line control circuit 40b one by one in the pixels 1a of two rows, it is possible to suppress the increase in the number of capacitive lines 40a. Therefore, it is possible to increase the transmissivity of the light source in each of the pixels 1a by decreasing the number of capacitive lines 40a. That is, it is possible to increase the aperture ratio of the pixels 1a. In addition, it is possible to simplify the circuit configuration by decreasing the number of capacitive line control circuits 40b.

In the second embodiment, since the v driver 20 is arranged at the positions sandwiching the display screen unit 1 one by one, that is, the two V drivers 20 are provided with the display screen unit 1 interposed therebetween, the distance of the gate line 20a from the v driver 20 to the pixels 1a can be decreased compared with the case where one V driver 20 is arranged. Accordingly, it is possible to suppress the increase in wire resistance and wire capacity. As a result, since a time constant can be reduced, it is possible to write the video signal to the pixels 1a with accuracy.

The other effect of the second embodiment is equal to that of the first embodiment.

### Third Embodiment

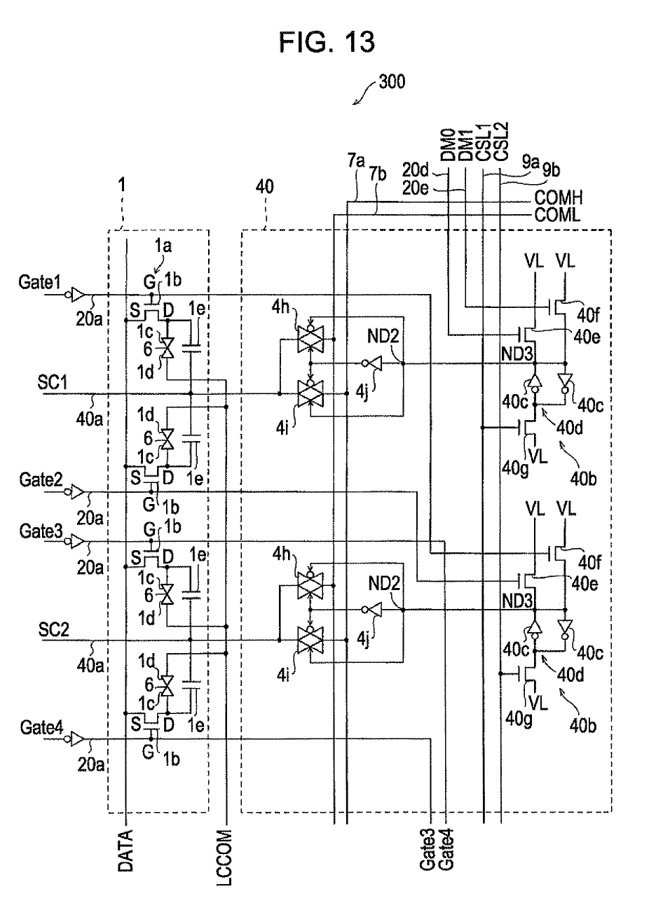

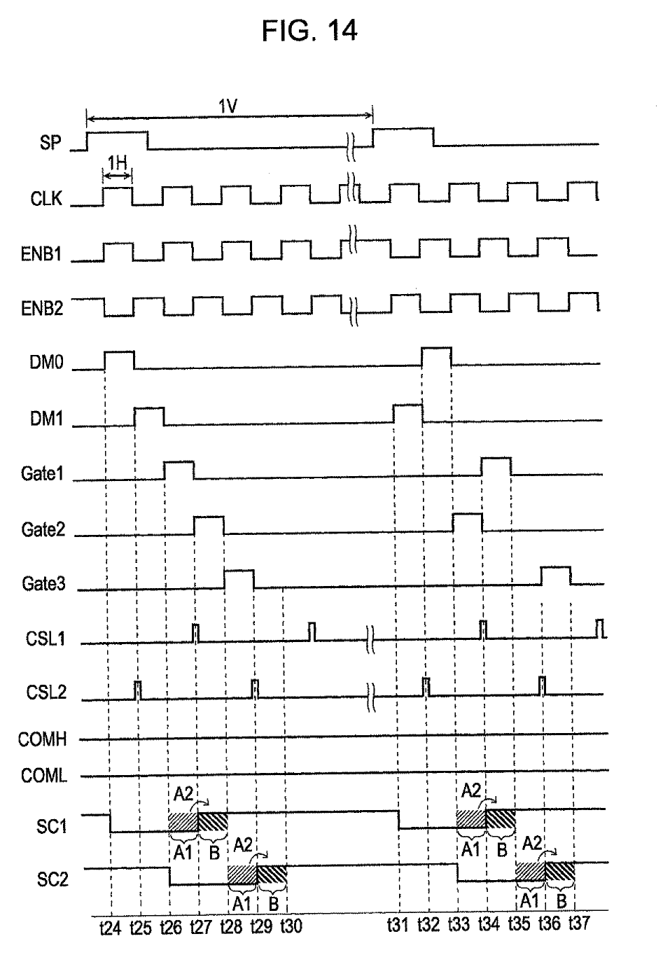

FIGS. 13 and 14 are views explaining the configuration of a liquid crystal display device according to a third embodiment of the invention. In the third embodiment, an example of driving capacitive Line control circuits 40b by two CSL signals (CSL1 and CSL2) will be described with reference to FIGS. 13 and 14, unlike the second embodiment in which the capacitive line control circuits 40b are driven by one CSL signal.

In the liquid crystal display device 300 according to the third embodiment of the invention, as shown in FIG. 13, a CSL1 signal is supplied to the capacitive line control circuit 40b of the odd-numbered stage and a CSL2 signal is supplied to the capacitive line control circuit 40b of the even-numbered stage. In detail, a CSL1 line 9a for supplying the CSL1 signal is connected to the gate of the transistor 40g in the capacitive line control circuit 40b of the odd-numbered stage and a CSL2 signal 9b for supplying the CSL2 signal is connected to the gate of the transistor 40g in the capacitive line control circuit 40b of the even-numbered stage.

The other configuration of the third embodiment is equal to that of the second embodiment.

Next, the operation when the video signal is written in the liquid crystal display device 300 according to the third embodiment of the invention will be described with reference to FIGS. 13 and 14.

First, the same operation as the operation of the time t10 (see FIG. 12) of the second embodiment is performed. That is, the dummy gate signal (DM0) having the H level is output from the dummy gate line 20d such that the potential of the capacitive line 40a of the first stage (the potential of SC1) is changed to the low potential side. At a time t25, the dummy gate signal (DM1) having the H level is output from the dummy gate line 20e and the signal having the H level is output from the CSL2 line 9b. The dummy gate signal (DM1) is supplied to the gate of the transistor 40f in the capacitive line control circuit 40b of the first stage such that the potential of the capacitive line 40a of the first stage (the potential of SC1) is continuously held at the low potential side. That is, in the second embodiment, the potential of the capacitive line 40a is changed to the low potential side, is then changed to the high potential state once by the CSL signal after the 1 H period, and is returned to the low potential side. In contrast, in the third embodiment, the potential of the capacitive line 40a changed to the low potential side is controlled to be continuously held at the low potential side in a period (2 H period) until the video signal is written.

The signal having the H level output from the CSL2 line 9b is supplied to the gate of the transistor 40g in the capacitive line control circuit 40b of the second stage. Accordingly, the potential of the capacitive line 40a of the second stage is continuously held at the high potential side. At a time t26, with respect to the pixels 1a of the first stage, the video signal corresponding to the high potential side is written in a state in which the potential of the capacitive line 40a is held at the low potential side.

At a time t27, the potential of the capacitive line 40a in the pixels 1a of the first stage, to which the video signal is written, is changed from the low potential side to the high potential side and thus the potential of the pixel electrode 1c of the pixels 1a corresponding thereto is also changed to the high potential side (a portion A1 of the drawing). At this time, the video signal corresponding to the low potential side is written to the pixels 1a of the second stage in a state in which the potential of the capacitive line 40a is held at the high potential side. The video signal is written by the same operation from the row of the upper end corresponding to the previous stage to the row of the lower end corresponding to the next stage.

Even in one next vertical period (1V period), similarly, at the time of writing the video signal, the potential of the capacitive line 40a changed to the low potential side once is controlled to be continuously held at the low potential side until the video signal is written. In the sequence of the writing of the video signal, similar to the second embodiment, the writing to the pixels 1a of the row of the first stage is performed after the writing to the pixels 1a of the row of the second stage. That is, the writing of the video signal from the pixels 1a of the lower stage to the pixels 1a of the upper stage for every rows of two stages is performed like Gate2, Gate1, Gate4, Gate3, . . . .

In the third embodiment, as described above, unlike the second embodiment, since the potential of the capacitive line 40a changed to the low potential side is controlled to be continuously held at the low potential side until the video signal is written by providing the two CSL signals (CSL1 and CSL2) in order to drive the capacitive line control circuit 40b, it is possible to suppress the unnecessary change of the potential of the capacitive line 40a at the time of writing the video signal. Accordingly, it is possible to write the video signal with accuracy.

The other effect of the third embodiment is equal to that of the second embodiment.

The disclosed embodiments have only been given by way of example for explanation of the invention and the range of the invention is not to be considered as being limited by the details of those embodiments. The range of the invention is expressed by claims instead of the description of the above embodiment, and all modifications are included in the claims and equivalent thereof.

For example, although, in the first to third embodiments, the example of arranging the capacitive line control circuit in one side of the display screen unit is described, the invention is not limited to this, and the capacitive line control circuits may be arranged at both sides of the display screen unit. Accordingly, it is possible to reduce the time constant by decreasing the distance (signal transmission path) from the capacitive line driving circuit of the capacitive line.

Although, in the first to third embodiments, the example in which the OFF potential of the gate signal is the reference potential, that is, the ground level (GND), of the liquid crystal display device is described, the invention is not limited to this. The OFF potential of the gate signal may be set to the ground potential or the low potential of the driving power source of the V driver 2.

Although, in the first to third embodiments, the example of applying the method of sequentially writing the video signal in one direction (single direction) with respect to the pixels to the invention is described, the invention is not limited to this. A method of writing the video signal in bi-direction with respect to the pixels is applicable to the invention.

The peripheral circuits such as driver circuit, the driving circuit, the driving IC and so on described in the first to third embodiment may be formed on the same glass substrate as the pixel electrodes on the substrate of the liquid crystal display device using a system-on-glass (SOG) technique. Accordingly, it is possible to reduce the number of semiconductor components, simplify assembling, decrease the size of the external circuit board, and realize reduction of weight, size and cost.

Although an example of applying the liquid crystal display device of the first embodiment of the invention to an electronic apparatus is described, the invention is not limited to this. The liquid crystal display devices of the second and third embodiments of the invention are applicable to the electronic apparatus according to the first embodiment.

The entire disclosure of Japanese Patent Application No. 2008-119953, filed May 1, 2008 are expressly incorporated by reference herein.

What is claimed is:

1. An electro-optical device comprising:
pixel electrodes provided in intersections of gate lines and data lines;
counter electrodes provided to face the pixel electrodes with an electro-optical material interposed therebetween; and
storage capacitors each of which one end is connected to each of the pixel electrodes,
wherein, if data line signals supplied to the pixel electrodes via the data lines correspond to writing of a positive polarity with respect to the potential of the counter electrodes, the potential of the other end of each of the storage capacitors is changed to a high potential side after the data line signals are written and, if the data line signals correspond to writing of a negative polarity with respect to the potential of the counter electrodes, the potential of the other end of each of the storage capacitors is held at a constant level before and after the data line signals are written.

2. The electro-optical device according to claim 1, further comprising:
pixel transistors connected to the pixel electrodes;
gate lines which supply gate signals for controlling ON/OFF of the pixel transistors;
a gate line scanning unit which scans the gate lines; and
a driving power source which supplies a driving power source potential to the gate line scanning unit,
wherein an OFF potential of the gate signals supplied to the pixel transistors becomes a reference potential of the electro-optical device.

3. The electro-optical device according to claim 2, further comprising:
capacitive lines connected to the storage capacitors; and
capacitive line control circuits which control the potentials of the storage capacitors via the capacitive lines,
wherein the capacitive line control circuits are connected to the gate lines, and control the potentials of the storage capacitors on the basis of the gate signals supplied from the gate lines.

4. The electro-optical device according to claim 3, wherein:
the capacitive line control circuits are provided in the capacitive lines, respectively,
a plurality of pixels having the pixel transistors, and a dummy gate line connected to the capacitive line control circuit arranged in correspondence with the capacitive line of a first stage are further included, and
a signal for controlling the potential of the storage capacitor corresponding to the capacitive line of the first stage is supplied from the capacitive line control circuit arranged in correspondence with the capacitive line of the first stage to the capacitive line of the first stage, on the basis of a dummy gate signal supplied by the dummy gate line.

5. The electro-optical device according to claim 4, wherein:
the plurality of pixels are arranged in a matrix, and
the data line signals supplied to the pixel electrodes are switched to the data line signals corresponding to the writing of the positive polarity with respect to the potential of the counter electrodes and the data line signals corresponding to the writing of the negative polarity with respect to the potential of the counter electrodes, for each horizontal line of the plurality of pixels arranged in the matrix.

6. The electro-optical device according to claim 4, wherein the capacitive line and the capacitive line control circuit are provided one by one in the pixels of one row.

7. The electro-optical device according to claim 4, wherein the capacitive line and the capacitive line control circuit are provided one by one in the pixels of a plurality of rows.

8. The electro-optical device according to claim 7, wherein a first writing mode for sequentially performing writing from the pixels of a previous stage to the pixels of a next stage one stage by one stage for each vertical period and a second writing mode for sequentially performing writing in order opposite to the first writing mode from the pixels of the previous stage to the pixels of the next stage for every two stages are alternately performed at the time of writing the data line signals.

9. The electro-optical device according to claim 4, further comprising:
a display unit including the plurality of pixels,
wherein the gate line scanning units are arranged at positions sandwiching the display unit one by one.

10. An electronic apparatus comprising the electro-optical device according to claim 1.
